(19) United States
(12) Patent Application Publication
(10) Pub. No.: US 2014/0020361 A1
(43) Pub. Date: Jan. 23, 2014

(54) EXHAUST GAS RECIRCULATION COOLER WITH A HEATED FILTER

(71) Applicant: GM GLOBAL TECHNOLOGY OPERATIONS LLC, Detroit, MI (US)

(72) Inventors: ALOK WAREY, TROY, MI (US); PATRICK G. SZYMKOWICZ, SHELBY TOWNSHIP, MI (US); SANDRO R. BALESTRINO, PLYMOUTH, MI (US)

(21) Appl. No.: 13/926,036

(22) Filed: Jun. 25, 2013

Related U.S. Application Data
(60) Provisional application No. 61/672,338, filed on Jul. 17, 2012.

(51) Int. Cl. F02M 25/07

(52) U.S. Cl. CPC F02M 25/0735
USPC 60/273; 60/278

(57) ABSTRACT

An apparatus for mitigating fouling within a heat exchanger device includes an internal combustion engine fluidly coupled to an intake manifold upstream of the engine and an exhaust gas manifold downstream of the engine. The apparatus further includes an external exhaust gas recirculation circuit fluidly coupled to the exhaust gas manifold at a first end and configured to selectively route exhaust gas flow into the intake manifold at a second end. The exhaust gas recirculation circuit includes the heat exchanger device for cooling the EGR flow prior to entering the intake manifold, and a deposit filter fluidly coupled upstream of the heat exchanger device and configured to trap combustion by-products within the EGR flow.

### CROSS REFERENCE TO RELATED APPLICATIONS

This application claims the benefit of U.S. Provisional Application No. 61/672,338, filed on Jul. 17, 2012, which is incorporated herein by reference.

### TECHNICAL FIELD

This disclosure is related to mitigating fouling in exhaust gas recirculation cooling devices for internal combustion engines.

### BACKGROUND

The statements in this section merely provide background information related to the present disclosure. Accordingly, such statements are not intended to constitute an admission of prior art.

Exhaust systems transport combustion by-products in the form of exhaust gas flow from the engine through various after treatment devices. Exhaust gas recirculation (EGR) circuits channel a portion of exhaust gas flow back to an intake gas flow to reenter the combustion chambers within cylinders of the engine. The effects associated with the use of EGR, for example the reduction of NOx emissions, are known in the art. EGR circuits are known for use in many different engine types and configurations, for instance in both diesel and gasoline engines.

The exhaust gas flow tapped from the exhaust system for the purpose of controlling combustion within the combustion chamber contain by-products of combustion. Particulate matter (PM) and other combustion by-products travel through the exhaust system with the exhaust gas flow. The recirculated gas flow tapped from the exhaust system is exposed to these by-products. A heat exchanger, such as an EGR cooler device, can include narrow and subdivided exhaust gas flow passages for maximizing heat transfer from the hot gas to a cooling liquid. These narrow exhaust gas flow passages with large surface areas can act as filters to the combustion by-products, collecting particulate deposits on the surfaces within the passages. Such surface deposits within the heat exchanger can have a number of adverse effects upon the heat exchanger, including but not limited to corrosion, increased flow resistance, flow blockage, reduction of heat transfer capacity and noise, vibration, and harshness (NVH). It is therefore desirable to remove surface deposits within the heat exchanger.

### SUMMARY

An apparatus for mitigating fouling within a heat exchanger device includes an internal combustion engine fluidly coupled to an intake manifold upstream of the engine and an exhaust gas manifold downstream of the engine. The apparatus further includes an external exhaust gas recirculation circuit fluidly coupled to the exhaust gas manifold at a first end and configured to selectively route exhaust gas flow into the intake manifold at a second end. The exhaust gas recirculation circuit includes the heat exchanger device for cooling the EGR flow prior to entering the intake manifold, and a deposit filter fluidly coupled upstream of the heat exchanger device and configured to trap combustion by-products within the EGR flow.

### BRIEF DESCRIPTION OF THE DRAWINGS

One or more embodiments will now be described, by way of example, with reference to the accompanying drawings, in which:

FIG. 1 illustrates an exemplary engine configuration utilizing an exhaust gas recirculation (EGR) circuit, in accordance with the present disclosure;

FIGS. 2 and 3 illustrate a deposit filter and a heat exchanger device of the EGR circuit of FIG. 1, in accordance with the present disclosure; and

FIG. 4 illustrates a flowchart for mitigating fouling in the heat exchanger device of FIG. 1, in accordance with the present disclosure.

### DETAILED DESCRIPTION

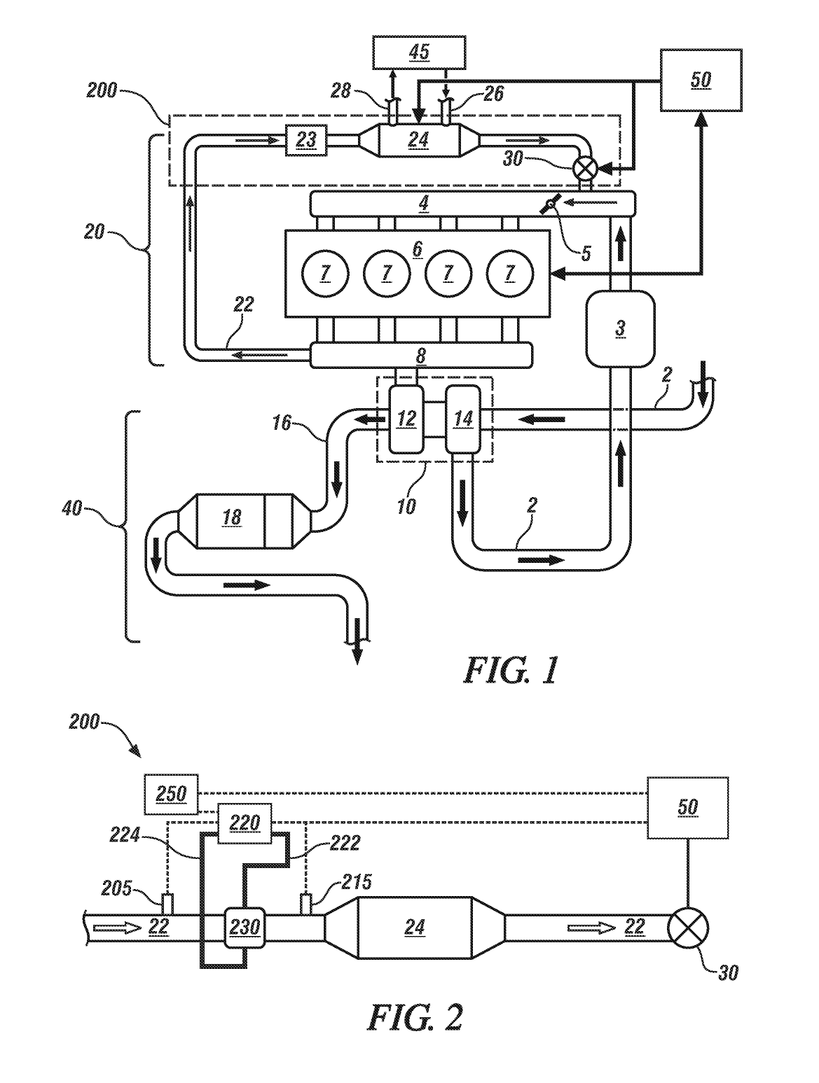

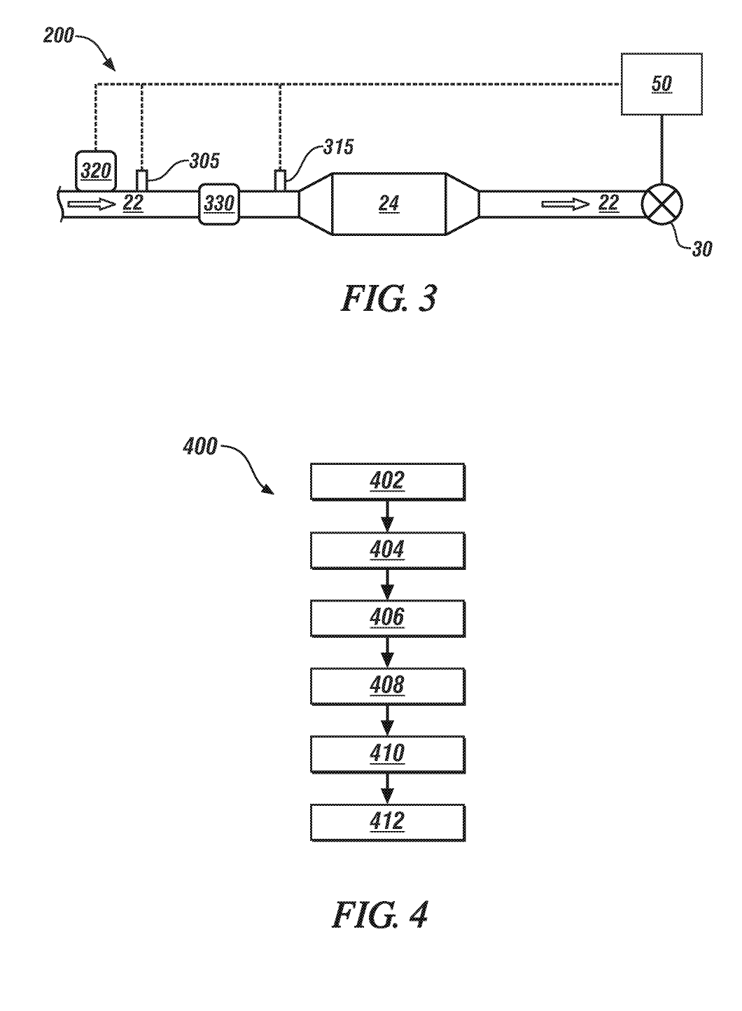

Referring now to the drawings, wherein the showings are for the purpose of illustrating certain exemplary embodiments only and not for the purpose of limiting the same, FIG. 1 illustrates an exemplary engine configuration utilizing an external exhaust gas recirculation (EGR) circuit in accordance with the present disclosure. An internal combustion engine 6 is includes an exhaust system 40, an intake manifold 4, a turbocharger 10 and the EGR circuit 20. The intake manifold 4 can be interchangeably referred to as an “intake gas manifold” herein. Portion 200 of EGR circuit 20 includes an EGR cooler device 24, a deposit filter 23, and an EGR valve 30. Portion 200 is described in greater detail with reference to FIGS. 2 and 3. The exemplary engine includes four cylinders 7. While the illustrated embodiment depicts four cylinders 7, the engine 6 may include additional or fewer cylinders 7. The engine 6 can have a V-type, W-type or inline-type cylinder configuration. In an exemplary embodiment, the engine 6 is a diesel engine. In an alternative embodiment, the engine 6 is a gasoline engine.

A control module 50 is operatively connected to the engine 6, and acquires data from sensors, and control a variety of actuators of the engine 6. The control module 50 can receive an engine torque command, and generate a desired torque output, based upon operator inputs. Exemplary engine operating parameters that are sensed by the control module 50 using the aforementioned sensors include engine coolant temperature, crankshaft rotational speed (RPM) and position, manifold absolute pressure, ambient air flow and temperature, and ambient air pressure. Combustion performance measurements typically include measured and inferred combustion parameters, including air-fuel ratio, and location of peak combustion pressure, among others.

Control module, module, control, controller, control unit, processor and similar terms mean any one or various combinations of one or more of Application Specific Integrated Circuit(s) (ASIC), electronic circuit(s), central processing unit(s) (preferably microprocessor(s)) and associated memory and storage (read only, programmable read only, random access, hard drive, etc.) executing one or more software or firmware programs or routines, combinational logic circuit(s), input/output circuit(s) and devices, appropriate signal conditioning and buffer circuitry, and other components to provide the described functionality. Software, firmware, programs, instructions, routines, code, algorithms and similar terms mean any instruction sets including calibrations and look-up tables. The control module has a set of control routines executed to provide the desired functions. Routines are executed, such as by a central processing unit, and are operable to monitor inputs from sensing devices and other networked control modules, and execute control and diagnostic routines to control operation of actuators. Routines may be executed at regular intervals, for example each 3.125, 6.25, 12.5, 25 and 100 milliseconds during ongoing engine and vehicle operation. Alternatively, routines may be executed in response to occurrence of an event.

In an exemplary embodiment, the turbocharger 10 is a variable geometry turbine (VGT) including a turbine 12 and a compressor 14. The compressor 14 is fluidly coupled to an intake conduit 2 for compressing fresh intake air from the environment. The turbine 12 can be a variable nozzle turbine (VNT) disposed in an exhaust conduit 16 of the exhaust system 40 for driving the compressor 14 through exhaust gas flow exiting the engine 6 from an exhaust manifold 8. The exhaust manifold 8 can be interchangeably referred to as an “exhaust gas manifold” herein.

In an exemplary embodiment, a charge air cooler 3 is fluidly coupled to the intake conduit 2 downstream of the compressor 14 of the turbocharger 10 for cooling the charged intake air before it reaches the intake manifold 4. After passing through the charge air cooler 3, the charged intake air is inlet to a plurality of intake ports through the intake manifold 4, each receiving the charged intake air passing through a known air metering device and a throttle device 5. Each cylinder defines a respective combustion chamber and includes one or more respective intake ports. An injected fuel mass is injected into each cylinder 7, and an air-fuel mixture including the charged intake air and the injected fuel mass is combusted and utilized to power the engine 6. The injected fuel mass can include pilot, main and post injections. In the exemplary embodiment, when the engine 6 is a diesel engine, the air-fuel mixture includes diesel fuel or diesel fuel blends. In alternative embodiments, when the engine 6 is a gasoline engine, the air-fuel mixture may include gasoline or gasoline blends, but the mixture may also include other flexible fuel types, such as ethanol or ethanol blends such as the fuel commonly known as E85. The methods described herein do not depend upon the particular variety of fuel used and are not intended to be limited to the embodiments disclosed herein.

The combusted air-fuel mixture is expelled from each cylinder 7 as an exhaust gas flow through the exhaust manifold 8. The exhaust gas flow can enter the exhaust system 40 and/or can enter the EGR circuit 20 for combustion in subsequent engine cycles. In an exemplary embodiment, the exhaust system 40 includes at least one aftertreatment device 18 in fluid communication with the exhaust conduit 16 downstream the turbine 12 of the turbocharger 10. When the engine 6 includes a diesel engine, the aftertreatment device 18 can include a diesel oxidation catalyst (DOC) for degrading residual hydrocarbons and carbon oxides contained in the exhaust gas flow. The aftertreatment device can further include a diesel particulate filter (DPF) fluidly coupled downstream of the DOC for capturing and removing diesel particulate matter (soot) from the exhaust gas flow. When the engine 6 includes a gasoline engine, the aftertreatment device 18 can include a three-way catalyst (TWC) for converting carbon oxides, hydrocarbons and oxides of nitrogen within the exhaust gas flow into carbon dioxide, nitrogen and water.

The EGR circuit 20 is fluidly coupled to the exhaust manifold 8 and is configured to selectively route back exhaust gas flow as EGR flow into the intake manifold 4. The EGR circuit 20 includes an EGR conduit 22 for directly fluidly coupling the exhaust manifold 8 with the intake manifold 4, an EGR cooler device 24 (e.g., EGR heat exchanger device) for cooling the exhaust gas flow and an EGR valve 30 downstream of the EGR cooler device 24 for controlling an EGR flow rate of exhaust gas flow through the EGR conduit 22. As used herein, the term “EGR flow” refers to exhaust gas flow that is routed through the EGR conduit 22. The EGR valve 30 is activated by control module 50. Various control methodologies for activating the EGR valve 30 under particular operating conditions are known in the art and will not be described in detail herein. The EGR valve 30, when controlled to an off position, blocks any exhaust gas flow from the exhaust manifold 8, the flow under a pressure gradient from the combustion process, from entering the intake manifold 4. The EGR valve 30, when controlled to an on or open position, opens, and the EGR circuit 20 can then utilize pressure and velocity of the exhaust gas flow to channel a portion of the exhaust gas flow to the intake manifold 4 as an EGR flow. The EGR valve 30, in some embodiments, is capable of opening partially, thereby modulating the amount of exhaust gas diverted into an EGR flow. It will be appreciated that the EGR valve 30 can be disposed upstream of the EGR cooler device 24. The EGR flow travels through the EGR circuit 20 to the intake manifold 4, where it is combined with at least the charged air portion of the air-fuel mixture in order to derive the combustion control properties enabled. The combustion process within the engine 6 is sensitive to conditions such as the temperature within the combustion chamber during combustion. EGR flow taken from a high temperature exhaust gas flow can increase the temperature within the combustion chamber to undesirable levels. Therefore, the EGR cooler device 24 removes heat from the EGR flow, thereby controlling the resulting temperature of the EGR flow eventually entering the combustion chamber. A cooling storage device 45 provides cooling via an inlet 26 to the EGR cooler device 24 that is recirculated back to the cooling storage device 45 via an outlet 28 of the EGR cooler device 24. Operation and efficiency of the EGR cooler device 24 is monitored by the control module 50. In one embodiment, the EGR cooler device 24 can be a gas to gas heat exchanger utilized to transfer heat from one gas flow to another. In another embodiment, the EGR cooler device 24 can be a gas to liquid heat exchanger utilized to transfer heat from a gas to a liquid. In the illustrated embodiment, the EGR cooler device 24 is a gas to liquid heat exchanger, wherein a high temperature EGR flow passes through EGR cooler device 24, transfers heat to a liquid medium in the form of an engine coolant liquid flow, the EGR flow thereafter exiting the EGR cooler device 24 as a reduced temperature EGR flow. Some known exemplary embodiments of EGR cooler device 24 include an engine coolant control device in communication with control module 50 capable of controlling flow and an amount of engine coolant liquid entering EGR cooler device 24, thereby controlling the amount of heat transferred from the EGR flow and controlling the reduction in temperature of the EGR flow. Under some operating conditions and configurations, the engine coolant liquid flow can be turned off such that EGR flow is delivered to the combustion chamber at a maximum temperature.

Heat exchangers and components thereof can be made of many materials. High temperatures exhibited within the exhaust gas flow influence the choice of materials used within heat exchangers coming into contact with the high temperature gases. In addition, corrosive combustion by-products present in the exhaust gases also influence the choice of materials used. Stainless steel is one known material used in exhaust components for its resistance to both high temperatures and corrosion. Certain other designs, wherein temperatures reaching the heat exchanger are somewhat lower and corrosive forces are mitigated, can utilize other materials such as aluminum. Other exemplary designs of heat exchangers utilize plastic or other synthetic materials, for example, to construct portions of headers or connective orifices wherein direct exposure to a higher temperature flow is not permitted. Heat exchangers are known to include various coatings to protect the structure of the heat exchanger or to impart other beneficial properties. The materials described above are given for example only. Choice of materials and coatings in particular heat exchangers are known in the art, and the materials and constructions of heat exchangers within this disclosure are not intended to be limited to the specific exemplary embodiments described herein.

Embodiments herein are directed towards mitigating fouling of the EGR cooler device 24. Fouling can occur as a result of by-products contained in the EGR flow resulting from combustion collecting on surfaces within gas flow passages of the EGR cooler device 24. The by-products collecting as surface deposits and forming a deposit layer within the EGR cooler device 24 can include particulate matter (PM), unburned hydrocarbons and other contaminants. The build-up of surface deposits within the EGR cooler device decreases the effectiveness and decreases the effective life of the EGR cooler device. PM and unburned hydrocarbon deposits left on the surfaces of the EGR cooler device 24 exposed to the gas flow act as an insulating blanket, decreasing the amount of heat that passes through the surfaces for a given temperature difference between the flow mediums. Accordingly, temperature differentials, or lack thereof, of the EGR cooler device 24 can indicate decreased heat transfer as a result of the fouling. Deposits built up upon the walls of the gas flow passages also decrease the effective cross sections of the gas flow passages, decreasing the flow of gas that flows through the gas flow passages of the EGR cooler device 24 for a given pressure difference across EGR cooler device 24. Accordingly, pressure drops of the EGR cooler device 24 can indicate increased flow resistance resulting from fouling. Especially in the presence of elevated temperatures present in the engine compartment and the EGR flow, the surface deposits within the gas flow passages promote corrosion and other degradation of the EGR cooler device 24.

In an exemplary embodiment, a deposit filter 23 is disposed within the conduit 22 of the EGR circuit 20 upstream of the EGR cooler device 24 to trap combustion by-products within the EGR flow in order to reduce surface deposit build-up within the flow passages of the EGR cooler device 24 and thereby mitigate fouling within the EGR cooler device 24. As aforementioned, combustion by-products can include PM, unburned hydrocarbons and other contaminants. The deposit filter 23 can function in the same manner as a diesel particulate filter commonly found in exhaust after treatment systems for diesel engines. The deposit filter 23 can further include a diesel oxidation catalyst. The deposit filter 23 can be disposed at any location within the EGR flow within the EGR circuit 20 that is upstream of the EGR cooler device 24 and can be disposed upstream immediately proximate to the EGR cooler device 24. In an exemplary embodiment, the deposit filter 23 is a metallic heated deposit filter configured to trap and filter out soot particles within the exhaust gas flow path, e.g., EGR flow path. The deposit filter 23 can be electrically heated to regenerate the deposit filter 23. In another exemplary embodiment, the deposit filter 23 is a catalytically heated deposit filter configured to trap and filter out soot particles within the exhaust gas flow path, e.g., EGR flow path. The deposit filter 23 can be catalytically heated using fuel energy to oxidize the accumulated deposits in the filter.

FIG. 2 illustrates in more detail the deposit filter 23 and the EGR cooler device 24 of the EGR circuit 20 encompassed by portion 200 of FIG. 1, in accordance with the present disclosure. In an exemplary embodiment, the deposit filter 23 includes an electrically heated deposit filter 230 fluidly coupled to the EGR conduit 22 upstream of the EGR cooler device 24. The electrically heated deposit filter 23 traps PM (soot), unburned hydrocarbons and other contaminants in the exhaust gas flow (i.e., EGR flow) to prevent surface deposit build-up producing a deposit layer in the flow passages in the EGR cooler device 24. As aforementioned, surface deposit build-up in the flow passages reduces heat transfer of the EGR cooler device 24 and increases flow resistance. The deposit filter 230 includes at least one heating element in thermal contact with the deposit filter 230. In the exemplary embodiment, the at least one heating element of the electrically heated deposit filter 230 is heated by drawing power from an electrical energy storage device (ESD) 220 to remove and oxidize trapped deposits within the deposit filter 230, and therefore, regenerate the deposit filter 230. In other words, the accumulated deposits in the deposit filter 230 are oxidized when the deposit filter 230 is electrically heated. The ESD 220 can include a battery or a capacitor and can be charged by a charging device 250 such as an alternator or any known charging methods. The power is drawn from the ESD 220 to the at least one heating element of the deposit filter 230 via positive and negative terminals 222, 224, respectively.

A first sensor 205 is disposed upstream of the electrically heated deposit filter 230 and a second sensor 215 is disposed downstream of the electrically heated deposit filter 230. In one embodiment, the first and second sensors 205, 215, respectively, can include pressure sensors for monitoring a pressure differential across the deposit filter 230. The pressure differential can be monitored by the control module 50. If a pressure drop exceeds a regeneration threshold, the control module 50 can command the electrically heated deposit filter 230 to draw power from the ESD 220 to heat the deposit filter 230 to remove, or otherwise oxidize, the accumulated deposits in the deposit filter 230.

FIG. 3 illustrates in more detail the deposit filter 23 and the EGR cooler device 24 of the EGR circuit 20 encompassed by portion 200 of FIG. 1, in accordance with the present disclosure. In an exemplary embodiment, the deposit filter 23 includes a catalytically heated deposit filter 330 fluidly coupled to the EGR conduit 22 upstream of the EGR cooler device 24. The catalytically heated deposit filter traps PM (soot), unburned hydrocarbons and other contaminants in the exhaust gas flow to prevent surface deposit build-up producing a deposit layer in the flow passages in the EGR cooler device 24. As aforementioned, surface deposit build-up in the flow passages reduces heat transfer of the EGR cooler device 24 and increases flow resistance. The catalytically heated deposit filter 330 includes catalytic material that reacts with fuel in the EGR flow to heat the deposit filter 330 by generating an exotherm across the deposit filter 330. The catalytically heated deposit filter 330 may remove and oxidize trapped deposits within the deposit filter 330, and therefore, regenerate the deposit filter 330. In other words, the accumulated deposits in the deposit filter 330 are oxidized when the deposit filter 330 is catalytically heated. In an exemplary embodiment, the catalytic material can include catalyst beds including platinum and/or palladium and/or rhodium.

In an exemplary embodiment, injected fuel masses are injected into the cylinders 7 during a post injection event, wherein unburned fuel (e.g., hydrocarbons) is transported through the exhaust gas flow and the EGR flow to the catalytically heated deposit filter 330. The unburned fuel thereby reacts with the catalytic material within the deposit filter 330 to heat the deposit filter 330, and thereby remove and oxidize trapped deposits within the deposit filter 330. The control module 50 can command the engine 6 to inject fuel into the cylinders 7 during post injection events when regeneration of the deposit filter 330 is required. For instance, the control module 50 can monitor the EGR valve 30 and determine that post injected fuel masses into the cylinders 7 to only be commanded when the EGR valve 30 is open because an EGR flow is necessary to transport the unburned fuel to the deposit filter 330.

In another exemplary embodiment, a fuel dosing device 320 is disposed upstream of the catalytically heated deposit filter 330. The fuel dosing device 320 can inject fuel into the exhaust gas feedstream, e.g., EGR flow, wherein the injected fuel mass is unburned and reacts with the catalytic material within the deposit filter 330 to heat the deposit filter 330, and thereby remove and oxidize trapped deposits within the deposit filter 330. The control module 50 can send a command to the fuel dosing device 320 to inject fuel when regeneration of the deposit filter 330 is required. For instance, the control module 50 can monitor the EGR valve 30 and determine that injected fuel masses into the EGR flow by the fuel dosing device 320 to only be commanded when the EGR valve 30 is open because an EGR flow is necessary to transport the unburned fuel to the deposit filter 330.

A first sensor 305 is disposed upstream of the electrically heated deposit filter 330 and a second sensor 315 is disposed downstream of the electrically heated deposit filter 330. In one embodiment, the first and second sensors 305, 315, respectively, can include pressure sensors for monitoring a pressure differential across the deposit filter 330. The pressure differential can be monitored by the control module 50. In one embodiment, if a pressure drop exceeds a regeneration threshold, the control module 50 can command the engine to inject a fuel mass into the cylinders 7 during post injection events, wherein unburned fuel is transported through the exhaust gas flow, e.g., EGR flow, to react with the catalytic material in the deposit filter 330 and remove, or otherwise oxidize, the accumulated deposits in the deposit filter 330. In another embodiment, if the pressure drop exceeds the regeneration threshold, the control module 50 can command the fuel dosing device 320 to inject a fuel mass into the exhaust gas flow, e.g., EGR flow, to react with the catalytic material in the deposit filter 330 and remove, or otherwise oxidize, the accumulated deposits in the deposit filter.

FIG. 4 illustrates a flowchart 400 for mitigating fouling in the EGR cooler device of FIG. 1, in accordance with the present disclosure. It will be appreciated that the exemplary flowchart 400 can be implemented within the control module 50 illustrated in FIG. 1. The flowchart 400 can be described with reference to FIGS. 2 and 3 that provide details of the EGR cooler device 24 of the EGR circuit 20 encompassed by portion 200 of FIG. 1. Table 1 is provided as a key to FIG. 4 wherein the numerically labeled blocks and the corresponding functions are set forth as follows.

TABLE 1

| BLOCK | BLOCK CONTENTS |
|---|---|
| 402 | Start. |
| 404 | Selectively route exhaust gas flow output from an internal |
| | combustion engine through an EGR circuit. |
| 406 | Cool the exhaust gas flow within an EGR cooler device of |
| | the EGR circuit prior to entering the intake manifold. |
| 408 | Trap combustion by-products within the exhaust gas flow |
| | within a deposit filter fluidly coupled upstream of the EGR |
| | cooler device. |
| 410 | Monitor a pressure differential across the deposit filter. |
| 412 | Regenerate the deposit filter when the monitored pressure |
| | differential exceeds a regeneration threshold. |

The flowchart starts at block 402 and proceeds to block 404 wherein exhaust gas flow output from the internal combustion engine 6 is selectively routed through the external EGR circuit 20. The exhaust gas flow within the EGR circuit 20 can be referred to as an EGR flow, wherein the EGR valve 30 controls the EGR flow rate through the EGR circuit 20. The EGR circuit 20 fluidly couples to the exhaust gas manifold 8 downstream of the engine 6 at a first end and fluidly couples to the intake gas manifold 4 upstream of the engine 6 at a second end.

Referring to block 406, the exhaust gas flow as EGR flow is cooled within the EGR cooler device 24 (i.e., heat exchanger device) of the EGR circuit 20 prior to entering the intake manifold. Specifically, the EGR cooler device 24 is a heat exchanger device that removes heat from the EGR flow to control the resulting temperature of the EGR flow that eventually enters the engine 6. In one embodiment, the EGR cooler device 24 can include a gas to gas EGR cooler device 24, wherein the EGR flow passes through the EGR cooler device 24 and transfers heat to a cooling gas. In another embodiment, the EGR cooler device 24 can include a gas to liquid EGR cooler device 24, wherein the EGR flow passes through the EGR cooler device 24 and transfers heat to a liquid medium. The cooling storage device 45 can provide the cooling (e.g., a liquid medium or a gas medium) via the inlet 26 of the EGR cooler device 24 that is recirculated back to the cooling storage device 45 via the outlet 28 of the EGR cooler device 24.

Referring to block 408, combustion by-products within the exhaust gas flow (e.g., EGR flow) are trapped within the deposit filter 23 that is fluidly coupled upstream of the EGR cooler device 24. As aforementioned, fouling that can occur as a result of the by-products contained in the EGR flow can result from combustion that collects on surfaces within gas flow passages of the EGR cooler device 24. The by-products collect as surface deposits that form a deposit layer within the EGR cooler device 24 can include particulate matter (PM), unburned hydrocarbons and other contaminants that can decrease the effectiveness and the effective life of the EGR cooler device 24. The deposit filter 23 disposed upstream of the EGR cooler device 24 is provided to trap these combustion by-products within the EGR flow in order to reduce surface deposit build-up within the flow passages of the EGR cooler device 24 and thereby mitigate fouling within the EGR cooler device 24. The deposit filter 23 can function in the same manner as a diesel particulate filter commonly found in exhaust after treatment systems for diesel engines. The deposit filter 23 can further include a diesel oxidation catalyst. The deposit filter 23 can be disposed at any location within the EGR flow within the EGR circuit 20 that is upstream of the EGR cooler device 24 and can be disposed upstream immediately proximate to the EGR cooler device 24. In an exemplary embodiment, the deposit filter 23 is a metallic heated deposit filter configured to trap and filter out soot particles within the exhaust gas flow path, e.g., EGR flow path. The deposit filter 23 can be electrically heated to regenerate the deposit filter 23. In another exemplary embodiment, the deposit filter 23 is a catalytically heated deposit filter configured to trap and filter out soot particles within the exhaust gas flow path, e.g., EGR flow path. The deposit filter 23 can be catalytically heated using fuel energy to oxidize the accumulated deposits in the filter.

Referring to block 410, a pressure differential across the deposit filter 23 is monitored. When the monitored pressure differential across the deposit filter 23 is greater than a regeneration threshold, the deposit filter 23 can be regenerated. The pressure differential is monitored based on a difference between a first pressure measured upstream of the deposit filter 23 and a second pressure measured upstream of the deposit filter 23. The first pressure can be measured by the first pressure sensor 205 and the second pressure can be measured by the second pressure sensor 215. Additionally, the EGR valve 30 downstream of the EGR cooler device 24 can be monitored, wherein the deposit filter 23 is only regenerated when the EGR valve 30 is one of opened and partially opened to permit the exhaust gas flow (e.g., EGR flow) through the deposit filter 23.

Referring to block 412, the deposit filter 23 is regenerated when the monitored pressure differential exceeds the pressure differential across the deposit filter 23. In one embodiment, when the deposit filter 23 includes a catalytically heated deposit filter, unburned fuel can be injected into the engine 6 during a post injection event to react with a catalytic material within the deposit filter 23 to heat the deposit filter 23 and oxidize the trapped combustion by-products during regeneration. In another embodiment, the catalytically heated deposit filter 23 can be regenerated through injection of unburned fuel into the EGR flow from the fuel dosing device 320 (e.g., see FIG. 3) disposed upstream of the deposit filter 23 to react with the catalytic material to heat the deposit filter 23 and oxidize the trapped combustion by-products. The catalytic material can be selected from the group consisting of: platinum, palladium, and rhodium. In yet another embodiment, when the deposit filter 23 includes an electrically heated deposit filter, at least one heating element in thermal contact with the deposit filter 23 can be electrically heated to oxidize the trapped combustion by-products. For instance, the at least one heating element can be electrically heated by drawing power from the ESD 220 of FIG. 2. As aforementioned, the ESD 220 can include a battery or a capacitor and can be charged by the charging device 250 such as an alternator or any known charging methods.

The disclosure has described certain preferred embodiments and modifications thereto. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

1. Apparatus for mitigating fouling within a heat exchanger device, comprising:
an internal combustion engine fluidly coupled to an intake manifold upstream of the engine and an exhaust gas manifold downstream of the engine; and
an external exhaust gas recirculation (EGR) circuit fluidly coupled to the exhaust gas manifold at a first end and configured to selectively route exhaust gas flow as EGR flow into the intake manifold at a second end, the EGR circuit including:
the heat exchanger device for cooling the EGR flow prior to entering the intake manifold, and
a deposit filter fluidly coupled upstream of the heat exchanger device and configured to trap combustion by-products within the EGR flow.

2. The apparatus of claim 1, wherein the EGR circuit further comprises a first pressure sensor disposed upstream of the deposit filter and a second pressure sensor disposed downstream of the deposit filter.

3. The apparatus of claim 1, wherein the deposit filter comprises an electrically heated deposit filter including at least one heating element heated by power drawn from an electrical energy storage device (ESD) during a regeneration event of the deposit filter.

4. The apparatus of claim 1, wherein the deposit filter comprises a catalytically heated deposit filter including a catalytic material that reacts with fuel in the EGR flow to heat the deposit filter during a regeneration event of the deposit filter.

5. The apparatus of claim 4, wherein the catalytic material is selected from the group consisting of: platinum, palladium, and rhodium.

6. The apparatus of claim 4, wherein the fuel that reacts with the catalytic material includes unburned fuel output from the engine.

7. The apparatus of claim 4, wherein the fuel that reacts with the catalytic material includes unburned fuel injected from a fuel dosing device disposed upstream of the catalytically heated deposit filter.

8. The apparatus of claim 1, further comprising:
an EGR valve downstream of the heat exchanger device for controlling an EGR flow rate of exhaust gas flow through the EGR circuit.

9. The apparatus of claim 1, wherein the heat exchanger device comprises one of:
a gas to gas heat exchanger device, wherein the EGR flow passes through the heat exchanger device and transfers heat to a cooling gas; and
a gas to liquid heat exchanger, wherein the EGR flow passes through the heat exchanger device and transfers heat to a liquid medium.

10. Method for mitigating fouling within an exhaust gas recirculation (EGR) cooler device, comprising:
selectively routing exhaust gas flow output from an internal combustion engine through an EGR circuit, the EGR circuit fluidly coupled to an exhaust gas manifold downstream of the engine at a first end and fluidly coupled to an intake gas manifold upstream of the engine at a second end;
cooling the exhaust gas flow within the EGR cooler device of the EGR circuit prior to entering the intake manifold; and
trapping combustion by-products within the exhaust gas flow within a deposit filter fluidly coupled upstream of the EGR cooler device.

11. The method of claim 10, further comprising:
regenerating the deposit filter when a pressure differential across the deposit filter is greater than a regeneration threshold.

12. The method of claim 11, further comprising:
monitoring an EGR valve downstream of the EGR cooler device for controlling an EGR flow rate of exhaust gas flow through the EGR circuit; and
regenerating the deposit filter only when the EGR valve is at least partially opened to permit the exhaust gas flow through the deposit filter.

13. The method of claim 11, wherein the pressure differential is monitored based on a difference between a first pressure measured upstream of the deposit filter and a second pressure measured downstream of the deposit filter.

14. The method of claim 11, wherein regenerating the deposit filter comprises:
injecting unburned fuel into the engine during a post injection event to react with a catalytic material within the deposit filter to heat the deposit filter and oxidize the trapped combustion by-products.

15. The method of claim 11, wherein regenerating the deposit filter comprises:
injecting unburned fuel into the exhaust gas flow from a fuel dosing device disposed upstream of the deposit filter to react with a catalytic material within the deposit filter to heat the deposit filter and oxidize the trapped combustion by-products.

16. The method of claim 11, wherein regenerating the deposit filter comprises:
electrically heating at least one heating element in thermal contact with the deposit filter to heat the deposit filter and oxidize the trapped combustion by-products.

17. The method of claim 16, wherein the at least one heating element is electrically heated by drawing power from an electrical energy storage device.

18. Apparatus for mitigating fouling within an external exhaust gas recirculation (EGR) cooler device, comprising:
an internal combustion engine fluidly coupled to an intake manifold upstream of the engine and an exhaust gas manifold downstream of the engine;
an EGR circuit fluidly coupled to the exhaust gas manifold at a first end and configured to selectively route exhaust gas flow as EGR flow into the intake manifold at a second end, the EGR circuit including:
the EGR cooler device for cooling the EGR flow prior to entering the intake manifold, and
a deposit filter fluidly coupled upstream of the heat exchanger device and configured to trap combustion by-products within the EGR flow; and
a control module configured to regenerate the deposit filter when a pressure differential across the deposit filter exceeds a regeneration threshold.

19. The apparatus of claim 18, wherein the deposit filter comprises one of:
an electrically heated deposit filter having at least one heating element to heat the deposit filter during regeneration; and
a catalytically heated deposit filter having a catalytic material that reacts with unburned fuel within the EGR flow to heat the deposit filter during regeneration.

20. The apparatus of claim 19, wherein the unburned fuel within the EGR flow is provided by at least one of:
a post injection event of the engine; and
a fuel dosing device disposed upstream of the catalytically heated deposit filter.
